(19) United States
(12) Patent Application Publication
(10) Pub. No.: US 2017/0355862 A1
(43) Pub. Date: Dec. 14, 2017

(54) FIRE-PROTECTION COMPOSITION AND USE OF THE SAME

(71) Applicant: HILTI AKTIENGESELLSCHAFT, Schaan (LI)

(72) Inventors: Juliane MARAUSKA, Kaltenkirchen (DE); Martin LANG, Planegg (DE); Sebastian SIMON, Buchloe Lindenberg (DE)

(73) Assignee: HILTI AKTIENGESELLSCHAFT, Schaan (LI)

(21) Appl. No.: 15/532,720

(22) PCT Filed: Nov. 30, 2015
(86) PCT No.: PCT/EP2015/078024

§ 371 Date: Jun. 2, 2017

(30) Foreign Application Priority Data
Dec. 5, 2014 (EP) 14196427.0

(51) Int. Cl. C09D 5/18; C09D 175/12; C08K 3/26; C08G 18/73; C09K 21/02; C08G 18/32

(52) U.S. Cl. CPC C09D 5/185; C09K 21/02; C08G 18/3225; C08K 3/26; C08G 18/73; C09D 175/12; C08K 2003/265

(57) ABSTRACT

A fire-protection composition is described that contains a polyurea-based binder. By virtue of the inventive composition, coatings having the layer thickness necessary for the respective fire-resistance duration can be applied simply and quickly, wherein the layer thickness can be reduced to a minimum and nevertheless a good fire-protection effect can be achieved. The inventive composition is suitable in particular for fire protection, especially as a coating of cables and cable runs, in order to increase the fire resistance duration.

The present invention relates to a fire-protection composition, especially an ablatively acting composition, which contains a polyurea-based binder, as well as the use of the same for fire protection, especially for coating of building parts, such as columns, beams, truss members, insulating systems, e.g. soft partitions, cables, cable bundles or cable runs, in order to increase the fire-resistance duration.

During fires, cable runs constitute particular hazard areas for several reasons. On the one hand, intense smoke development with emission of harmful and sometimes toxic substances occurs during fires involving plastic-insulated cables. On the other hand, a fire may spread rapidly along cable runs, so that under certain circumstances the fire propagates to a location far removed from the original seat of the fire. For cable systems the further problem exists that the effect of the insulation of these cables will decline due to the effects of heat or burning and that short-circuiting may lead to interruption of the current flow and thus to destruction of the cables.

Electrical cables and lines are frequently laid in hallways and in the adjacent rooms. In the event of fire, these hallways serve as escape and rescue routes, but if the fires involve cable installations they become unusable due to smoke development and toxic fire gases. For example, burning PVC releases strongly corrosive gases.

Cable assemblies therefore represent a considerable hazard potential, especially in industrial construction, in power plants, in hospitals, in large-scale constructions and administrative buildings and generally in buildings with high installation density. In these buildings, the cable insulations often constitute the determining fire load, causing long-lasting fires with temperatures up to 1000° C. and higher in the worst cases in the fire space. For the cited reasons, special attention must be paid to cable runs from the viewpoint of fire-protection measures.

In order to prevent these hazards of lack of functionality of the cables and of serious exaggeration of the fire load due to the cables, at least for a limited time, it is known to separate the cables spatially by incombustible building materials of building-material class A1 or A2, for example, by laying the cables in installation and/or functional integrity ducts. However, this necessitates space-consuming constructions, which must take into consideration the weight of the installation and/or functional integrity ducts. For this purpose, cables and cable runs are often wrapped with insulating materials, such as alumina-silica mats or mineral-wool mats. To achieve adequate fire protection, the material must be very thick. However, this leads to problems of spacing between the protected object and neighboring or overlaid objects. Furthermore, these materials cause problems during normal operation, due to their thermal insulation properties. One of these problems is known as “lowering of the current-carrying capacity”. This means that the heat generated by electrical cables in the cable conduit or cable run can no longer be dissipated in the region of the insulation, with the consequence that reliable, safe current operating levels in these cables are reduced or that the cables become overheated. These disadvantages make this type of fire protection very inflexible with respect to its scope of application.

To avoid these disadvantages, it is also known to apply, for protection of electrical cables, coatings that foam up due to the effect of heat during a fire and thus form an insulating layer, or that absorb heat by physical or chemical processes and thus have a cooling effect.

With coatings that form insulating layers, it is possible to prevent cables from becoming involved in the fire event for 30 minutes or longer. Such coated cables are often laid in cable runs. In this connection, however, it has been found that even an insulating-layer-forming material that has foamed up completely cannot prevent fire from spreading without additional measures if the cable runs are vertical or inclined. During heating, the cables warm up so intensely between the cable clamps that the coating forming the insulating layer tears and to some extent flakes off. The resulting foam then also becomes detached from the cables and forms drips. If coating is performed after the cables have been laid, the cables in the region of the clamp structures are not completely accessible. This has the consequence that, when the cable runs have a vertical or inclined arrangement, only a foam of low density is formed in the region of the clamp structures in the event of fire, and so it is no longer sufficient for 30 minutes of fire protection. Thus the problems known for the fire situation are again encountered for laying of PVC cables.

It is also known to use halogen-free cables with flame-retardant or low-flammability finish, so that they are hardly inflammable, generate little smoke and have only low fire-propagation capacity. However, these cables are very expensive and therefore are used only under extremely vulnerable conditions.

To avoid the disadvantages of insulation-layer-forming coatings, materials having an ablation effect, which means they have a cooling effect and ceramize under the effect of heat, as described in DE 196 49 749 A1, for example, are applied on the cables and cable supports in cable runs. What is described herein is a method for forming fire protection for combustible or heat-threatened building parts, wherein the building parts are provided with a coating containing, as binder, an inorganic material of finely ground hydraulic binders such as calcium silicate, aluminate or ferrite, to which ablative substances such as aluminum or magnesium hydroxide has been added. Disadvantages of this measure are that, on the one hand, the application of the material with the ablation effect is time-consuming and, on the other hand, the adhesion of the material to the cables and cable supports represents a problem.

Other coating systems that are currently on the market and do not have some of the disadvantages mentioned in the foregoing are one-component coating compositions on the basis of polymer dispersions, which contain endothermically decomposing compounds. One disadvantage of these coatings is the relatively long duration of drying of the coating and the accompanying small thickness of the dried layer, since these systems dry physically, i.e. by evaporation of the solvent. Therefore several successive applications are necessary for thicker coatings, also making these systems time-consuming and laborious and therefore uneconomical.

The object of the invention is to create an ablatively acting coating system of the type mentioned in the introduction, which avoids the cited disadvantages, which in particular is not solvent-based or water-based and exhibits rapid curing, can be easily applied due to appropriately adjusted viscosity and requires only a small layer thickness by virtue of the attainable high degree of filling.

This object is solved by the composition according to claim 1. Preferred embodiments can be found in the dependent claims.

Accordingly, the subject matter of the invention is a fire-protection composition with an ingredient A, which contains an isocyanate compound, with an ingredient B, which contains a reactive component capable of reacting with isocyanate compounds and selected from among compounds with at least two amino groups, wherein the amino groups, independently of one another, are primary and/or secondary amino groups and/or from compounds of polyols, and with an ingredient C, which contains an ablatively acting fire-protection additive.

By virtue of the inventive composition, coatings having the layer thickness necessary for the respective fire-resistance duration can be applied simply and quickly. The advantages achieved by the invention can be seen mainly in the fact that it has been possible to shorten the curing times compared with other known systems, such as solvent-based or water-based systems, so significantly that the working time is considerably reduced.

A further advantage lies in the fact that the inventive composition is able to achieve a high degree of filling with the fire-protection additives, so that a large insulating effect is achieved even with thin layers. The high degree of filling possible with the composition can be achieved even without the use of highly volatile solvents. Accordingly the material outlay is reduced, which favorably influences the material costs, especially for large-area applications. This is achieved in particular by the use of a reactive system, which does not dry physically but instead cures chemically via an addition reaction. Thus the compositions do not suffer any loss of volume due to the drying of solvents or of water in the case of water-based systems. For example, a solvent content of approximately 25% is typical in a traditional system. This means that, from a wet-film layer of 10 mm, only 7.5 mm remains as the actual protective layer on the substrate to be protected. With the inventive composition, more than 95% of the coating remains on the substrate to be protected.

In the event of fire, the binder softens and the fire-protection additives contained therein decompose in an endothermic physical or chemical reaction, depending on the additives used, with formation of water and inert gases, which leads on the one hand to cooling of the cables and on the other to dilution of the combustible gases or to formation of a protective layer, which protects the substrate from the action of heat and oxygen, and which also prevents the fire from spreading by burning away the coating.

The inventive coatings exhibit excellent adhesion to different underlying surfaces compared with solvent-based or water-based systems when they are applied without priming, and so they can be universally used and adhere not only to the lines to be protected but also to other carrier materials.

For better understanding of the invention, the following explanations of the terminology used herein are considered to be useful. Within the meaning of the invention:
the term “aliphatic compound” encompasses acyclic and cyclic saturated or unsaturated hydrocarbon compounds that are not aromatic (PAC, 1995, 67, 1307; Glossary of class names of organic compounds and reactivity intermediates based on structure (IUPAC Recommendations 1995));
“polyamine” means a saturated open-chain or cyclic organic compound, which especially in the case of open-chain compounds has primary amino groups (—NH₂) at the chain ends and which as the case may be is interrupted by a varying number of amino groups (—NH—); the term “polyamine” also encompasses polyether amines, also known as alkoxylated polyamines or polyoxyalkylene polyamines, i.e. compounds with aliphatically bound amino groups, wherein the amino groups are attached at the ends of a polyether structure;
“organic group” means a hydrocarbon group, which may be saturated or unsaturated, substituted or unsubstituted, aliphatic, aromatic or araliphatic, where “araliphatic” means that both aromatic and aliphatic groups are present;
“ablatively acting” means that, under the effect of elevated temperatures, i.e. above 200° C., as may occur in the event of fire, for example, a series of chemical and physical reactions take place that need energy in the form of heat, in which case this energy is drawn from the surroundings; this term is used synonymously with the term “endothermically decomposing”.

As the isocyanate compound, it is possible to use all aliphatic and/or aromatic isocyanates, known to the person skilled in the art, with an average NCO— functionality of 2 or higher, individually or in any desired mixtures with one another.

Examples of polyisocyanates are 1,4-phenylene diisocyanate, 2,4- and/or 2,6-toluylene diisocyanate, xylylene diisocyanate, hydrogenated xylylene diisocyanate, tetramethylxylylene diisocyanate, 1,5-naphthalene diisocyanate, diphenylenemethane-2,4′- and/or -4,4′-diisocyanate, triphenylmethane-4,4′, 4″-triisocyanate and bis- and tris-(isocyanatoalkyl)-benzenes, -toluenes and -xylenes.

Isocyanates from the series of aliphatic species are preferred, wherein they have a carbon skeleton (without the NCO— groups it contains) of 3 to 30, preferably 4 to 20 carbon atoms. Examples of aliphatic polyisocyanates are bis-(isocyanatoalkyl) ethers or alkane diisocyanates, such as propane diisocyanates, butane diisocyanates, pentane diisocyanates, hexane diisocyanates (e.g. hexamethylene diisocyanate, HDI), heptane diisocyanates, octane diisocyanates, nonane diisocyanates (e.g. trimethyl-HDI (TMDI), usually as a mixture of the 2,4,4- and 2,2,4-isomers), 2-methylpentane-1,5-diisocyanate (MPDI), nonane triisocyanates (e.g. 4-isocyanatomethyl-1,8-octane diisocyanate), decane diisocyanates, decane triisocyanates, undecane diisocyanates, undecane triisocyanates, dodecane diisocyanates, dodecane triisocyanates, 1,3- as well as 1,4-bis-(isocyanatomethyl)cyclohexanes (H₆XDI), 3-isocyanatomethyl-3,5,5-trimethylcyclohexyl isocyanate (isophorone diisocyanate, IPDI), bis-(4-isocyanatocyclohexyl)methane (H₁₂MDI), bis-(isocyanatomethyl)norbornane (NBDI) or 3(4)-isocyanatomethyl-1-methyl-cyclohexyl isocyanate (IMCI).

Particularly preferred isocyanates are hexamethylene diisocyanate (HDI), trimethyl-HDI (TMDI), 2-methylpentane-1,5-diisocyanate (MPDI), isophorone diisocyanate (IPDI), 1,3- as well as 1,4-bis(isocyanatomethyl)cyclohexane (H₆XD1), bis(isocyanatomethyl)norbornane (NBDI), 3(4)-isocyanatomethyl-1-methyl-cyclohexyl isocyanate (IMCI) and/or 4,4′-bis(isocyanatocyclohexyl)methane (H₁₂MDl) or mixtures of these isocyanates.

More preferably, the polyisocyanates exist as prepolymers, biurets, isocyanurates, iminooxadiazinediones, uretdiones and/or allophanates, synthesized by reaction with polyols or polyamines, individually or as mixtures, and have an average functionality of 2 or higher.

Examples of suitable commercially available isocyanate are Desmodur® N 3900, Desmodur® N 100, Desmodur® N 3200, Desmodur® N 3300, Desmodur® N 3600, Desmodur® N 3800, Desmodur® XP 2675, Desmodur® 2714, Desmodur® 2731, Desmodur® N 3400, Desmodur® XP 2580, Desmodur® XP 2679, Desmodur® XP 2731, Desmodur® XP 2489, Desmodur® E 305, Desmodur® E 3370, Desmodur® XP 2599, Desmodur® XP 2617, Desmodur® XP 2406, Desmodur® VL, Desmodur® VL 50, Desmodur® VL 51 (all of Bayer MaterialScience AG), Tolonate HDB, Tolonate HDT (Rhodia), Basonat HB 100 and Basonat HI 100 (BASF).

The reactive components of the amines used that are capable of reacting with isocyanate compounds comprise all compounds with at least two amino groups, wherein the amino groups of primary and/or secondary amino groups are capable of reacting with isocyanate groups to form a urea group (—N—C(O)—N—), and wherein these compounds are known to the person skilled in the art.

In one embodiment of the invention, the reactive component capable of reacting with isocyanate compounds is a polyamine, such as, for example 1,2-diaminocyclohexane, 4,4′-diaminodiphenylsulfone, 1,5-diamino-2-methylpentane, diethylenetriamine, hexamethylenediamine, isophoronediamine, triethylenetetramine, trimethylhexamethylenediamine and 5-amino-1, 3,3-trimethylcyclohexane-1-methylamine.

These polyamines are highly reactive towards isocyanate groups, and so the reaction between the amino group and the isocyanate group takes place within a few seconds.

Compounds that react less rapidly with the isocyanate groups, such as the so-called polyether polyamines, are therefore preferred. The polyether polyamines, also known as alkoxylated polyamines or polyoxyalkene polyamines, comprise compounds with aliphatically bound amino groups, i.e. the amino groups are attached at the ends of a polyether structure. The polyether structure is based on pure or mixed polyalkylene oxide units, such as polyethylene glycol- (PEG) and polypropylene glycol (PPG). The polyether structure can be obtained by reacting a dihydric or trihydric alcohol initiator with ethylene oxide (EO) and/or propylene oxide (PO) and then converting the terminal hydroxyl groups to amino groups.

Suitable Polyether Polyamines are Represented by the Following General Formula (I)

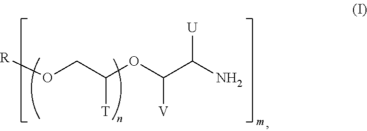

in which
R is the group of an initiator for oxalkylation with 2 to 12 carbon atoms and 2 to 8 groups containing active hydrogen atoms,
T represents hydrogen or a C₁-C₄ alkyl group
V and U, independently of one another, are hydrogen or T,
n is a value between 0 and 100,
m is a whole number between 2 and 8, wherein m corresponds to the number of groups that contain an active hydrogen atom and that were initially contained in the initiator for oxalkylation.

In further embodiments, n has a value between 35 and 100 or smaller than 90, smaller than 80 and smaller than 70 or smaller than 60. In a further embodiment, R has 2 to 6 or 2 to 4 or 3 groups containing active hydrogen atoms, especially hydroxyl groups. In another embodiment, R is an aliphatic initiator with several active hydrogen atoms. In a further embodiment, T, U and V are each methyl groups.

In this connection, reference is made to U.S. Pat. No. In 4,940,770 and Applications DE 26 09 488 Al and WO 2012/030338 A1, the contents of which are incorporated herewith in the present Application.

Examples of suitable polyether amines are the polyether amines of the D, ED, EDR and T series marketed by Huntsman Corporation under the brand JEFFAMINE®, wherein the D series comprises diamines and the T series triamines, the E series comprises compounds having a structure that consists substantially of polyethylene glycol and the R series comprises highly reactive amines.

The products of the D series comprise amino-terminated polypropylene glycols of general formula (II),

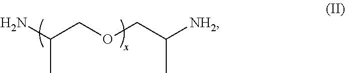

in which x is a number with a mean value between 2 and 70. Commercially available products from this series are JEFFAMINE® D-230 (n˜2.5/MW 230), JEFFAMINE® D-400 (n˜6.1/MW=430), JEFFAMINE® D-2000 (n˜33/MW 2,000) and JEFFAMINE® D-4000 (n˜68/MW 4,000).

The products of the ED series comprise amino-terminated polyethers on the basis of a substantially polyethylene glycol structure with general formula (III),

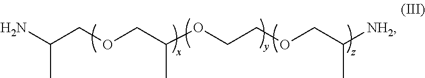

in which y is a number with a mean value between 2 and 40 and x+z is a number with a mean value between 1 and 6. Commercially available products from this series are: JEFFAMINE® HK511 (y=2.0; x+z˜1.2/MW 220), JEFFAMINE® ED-600 (y˜9.0; x+z -3.6/MW 600), JEFFAMINE® ED-900 (y˜12.5; x+z˜6.0/MW 900) and JEFFAMINE® ED-2003 (y˜39; x+z˜6.0/MW 2,000).

The products of the EDR series comprise amino-terminated polyethers with general formula (IV),

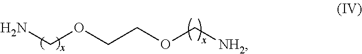

in which x is a whole number between 1 and 3. Commercially available products from this series are: JEFFAMINE® DER-148 (x=2/MW 148) and JEFFAMINE® DER-176 (x=3/MW 176).

The products of the T series comprise triamines, which are obtained by reaction of propylene oxide with a triol initiator and subsequent amination of the terminal hydroxyl groups, and which have general formula (V), or isomers thereof.

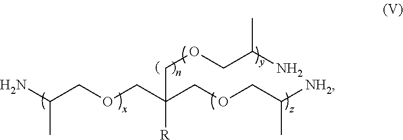

in which R is hydrogen or a C₁-C₄ alkyl group, preferably hydrogen or ethyl, n is 0 or 1 and x+y+z corresponds to the number of moles of propylene oxide units, wherein x+y+z is a whole number between approximately 4 and approximately 100, especially between approximately 5 and approximately 85. Commercially available products from this series are: JEFFAMINE® T-403 (R=C₂H₅; n=1; x+y+z=5-6/MW 440), JEFFAMINE® T-3000 (R=H; n=0; 30 x+y+z=50/MW 3,000) and JEFFAMINE® T-5000 (R=H; n=0; x+y+z=85/MW 5,000).

Furthermore, the secondary amines of the SD and ST series are suitable, wherein the SD series comprises secondary diamines and the ST series secondary triamines, which are obtained from the above series by reductive alkylation of the amino groups, in which the amino end groups are reacted with a ketone, for example acetone, and then reduced, so that sterically hindered secondary amino end groups with general formula (VI) are obtained.

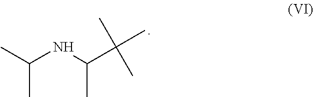

Commercially available products from this series are: JEFFAMINE® SD-231 (starting product D230/MW 315), JEFFAMINE® SD-401 (starting product D-400/MW 515), JEFFAMINE® SD-2001 (starting product D-2000/MW 2050) and JEFFAMINE ST-404 (starting product T-403/MW 565).

In a particularly preferred embodiment of the invention, polyaspartic acid esters, otherwise known as polyaspartics, are used as the reactive component capable of reacting with isocyanate compounds, since their reactivity toward isocyanate groups is greatly reduced compared with the other polyamines described in the foregoing. This leads to the advantage that the processing time for a composition with an isocyanate ingredient and a polyaspartic acid ester ingredient is prolonged, which leads to better manipulability by the user.

Suitable polyaspartic acid esters are selected from among compounds of general formula (VII),

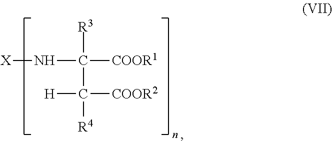

in which R¹ and R² may be identical or different and stand for organic groups that are inert toward isocyanate groups, R³ and R⁴ may be identical or different and stand for hydrogen or organic groups that are inert toward isocyanate groups, X stands for an n-valent organic group that is inert toward isocyanate groups and n stands for a whole number of at least 2, preferably 2 to 6, more preferably of 2 to 4 and most preferably of 2. R¹ and R², independently of one another, stand for a hydrocarbon group, which may or may not be substituted, preferably a C₁-C₉ hydrocarbon group and more preferably a methyl, ethyl or butyl group, and R³ and R⁴ preferably each stand for hydrogen.

In one embodiment, X stands for an n-valent hydrocarbon group, which is obtained by removal of the amino groups from an aliphatic or araliphatic polyamine, preferably by removal of the primary amino groups from an aliphatic polyamine, particularly preferably diamine. In this connection, the term polyamine encompasses compounds with two or more primary and as the case may be additional secondary amino groups, wherein the primary amino groups are preferably in terminal positions.

In a preferred embodiment, X stands for a group such as is obtained by removal of the primary amino groups from 1,4-diaminobutane, 1,6-diaminohexane, 2,2,4- or 2,4,4-trimethyl-1,6-diaminohexane, 1-amino-3,3,5-trimethyl-5-aminomethylcyclohexane, 4,4′-diamino-dicyclohexylmethane or 3,3′-dimethyl-4,4′-diamino-dicyclohexylmethane, diethylenetriamine and triethylenetetramine, and wherein n in formula (VII) stands for the number 2.

In this connection, reference is made to Applications EP 0 403 921 A2 and EP 0 743 332 A1, the contents of which are incorporated herewith in the present Application.

Mixtures of polyaspartic acid esters may also be used.

Examples of suitable polyaspartic acid esters are marketed by Bayer MaterialScience AG under the brand DESMOPHEN®. Examples of commercially available products are: DESMOPHEN® NH 1220, DESMOPHEN® NH 1420 and DESMOPH EN® NH 1520.

The described reactive components capable of reacting with isocyanate compounds may be used individually or as mixtures, depending on the desired reactivity. In this connection, the polyamines in particular may be used as bridging compounds, when they are used in addition to the polyether polyamines or the polyaspartic acid esters.

The quantitative ratios of ingredients A and B are preferably chosen such that the equivalent ratio of isocyanate groups of the isocyanate compound to groups, capable of reacting with the isocyanate group, of the reactive component capable of reacting with isocyanate compounds lies between 0.3 and 1.7, preferably between 0.5 and 1.5 and more preferably between 0.7 and 1.3.

Preferably the polyol is used together with the polyamine, polyether amine or polyaspartic acid ester in the OH:NH ratio of 0.05 eq:0.95 eq to 0.6 eq:0.4 eq, more preferably in the ratio of 0.1 eq:0.9 eq to 0.5 eq:0.5 eq and most preferably in the ratio of 0.2 eq:0.8 eq to 0.4 eq:0.6 eq.

Preferably the polyol is composed of a skeleton of polyester, polyether, polyurethane and/or alkanes or mixtures thereof with one or more hydroxyl groups. The skeleton may be linear or branched and the functional hydroxyl groups may be terminal and/or along the chain.

More preferably, the polyester polyols are selected from condensation products of di- and polycarboxylic acids, e.g. aromatic acids such as phthalic acid and isophthalic acid, aliphatic acids such as adipic acid and maleic acid, cycloaliphatic acids such as tetrahydrophthalic acid and hexahydrophthalic acid and/or their derivatives, such as anhydrides, esters or chlorides, and an excess quantity of multifunctional alcohols, e.g. aliphatic alcohols such as ethanediol, 1,2-propanediol, 1,6-hexanediol, neopentyl glycol, glycerol, trimethylolpropane and cycloaliphatic alcohols such as 1,4-cyclohexanedimethanol.

Furthermore, the polyester polyols are selected from among polyacrylate polyols, such as copolymers of esters of acrylic and/or methacrylic acid, such as, for example, ethyl acrylate, butyl acrylate, methyl methacrylate with additional hydroxy groups, and styrene, vinyl esters and maleic acid esters. The hydroxyl groups in these polymers are introduced via functional esters of acrylic and methacrylic acid, e.g. hydroxyethyl acrylate, hydroxyethyl methacrylate and/or hydroxypropyl methacrylate.

Furthermore, the polyester polyols are selected from among polycarbonate polyols. Usable polycarbonate polyols are polycarbonates containing hydroxyl groups, for example polycarbonate diols. These are obtainable by reaction of carboxylic acids or carboxylic acid derivatives with polyols or by the copolymerization of alkylene oxides, such as propylene oxide, for example, with CO₂. Additionally or alternatively, the polycarbonates used are formed from linear aliphatic chains. Suitable carboxylic acid derivatives are, for example, carboxylic acid esters, such as, for example, diphenyl carbonate, dimethyl carbonate or phosgene. Examples of suitable polyols are diols, such as ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentanedio1-1,3, dipropylene glycol, polypropylene glycols, dibutylene glycol, polybutylene glycols, bisphenol A and lactone-modified diols of the foregoing types.

Instead of or in addition to pure polycarbonate diols, polyether polycarbonate diols may also be used.

Furthermore, the polyester polyols are selected from among polycaprolactone polyols, synthesized by ring-opening polymerization of c-caprolactone with multifunctional alcohols, such as ethylene glycol, 1,2-propanediol, glycerol and trimethylolpropane.

More preferred are also polyether polyols selected from among addition products of, for example, ethylene oxide and/or propylene oxide and multifunctional alcohols such as, for example, ethylene glycol, 1,2-propanediol, glycerol and/or trimethylolpropane.

More preferred are also polyurethane polyols synthesized from polyaddition of diisocyanates with excess quantities of diols and/or polyols.

More preferred are also difunctional or multifunctional alcohols selected from C₂-C₁₀ alcohols with the hydroxyl groups at the ends and/or along the chain.

Most preferred are the aforesaid polyester polyols, polyether polyols and C₂-C₁₀ alcohols that are difunctional and/or trifunctional.

Examples of suitable polyester polyols include DESMOPHEN® 1100, DESMOPH EN® 1652, DESMOPHEN® 1700, DESMOPHEN® 1800, DESMOPHEN® 670, DESMOPHEN® 800, DESMOPHEN® 850, DESMOPHEN® VP LS 2089, DESMOPHEN® VP LS 2249/1, DESMOPHEN® VP LS 2328, DESMOPHEN® VP LS 2388, DESMOPHEN® XP 2488 (Bayer), K-FLEX XM-360, K-FLEX 188, K-FLEX XM-359, K-FLEX A308 and K-FLEX XM-332 (King Industries).

Examples of suitable commercially available polyether polyols include: ACCLAIM® POLYOL 12200 N, ACCLAIM® POLYOL 18200 N, ACCLAIM® POLYOL 4200, ACCLAIM® POLYOL 6300, ACCLAIM® POLYOL 8200 N, ARCOLO POLYOL 1070, ARCOLO POLYOL 1105 S, DESMOPHEN® 1110 BD, DESMOPHEN® 1111 BD, DESMOPHEN® 1262 BD, DESMOPHEN® 1380 BT, DESMOPHEN® 1381 BT, DESMOPHEN® 1400 BT, DESMOPHEN® 2060 BD, DESMOPHEN® 2061 BD, DESMOPHEN® 2062 BD, DESMOPHEN® 3061 BT, DESMOPHEN® 4011 T, DESMOPHEN® 4028 BD, DESMOPHEN® 4050 E, DESMOPHEN® 5031 BT, DESMOPHEN® 5034 BT and DESMOPHEN® 5035 BT (Bayer) or mixtures of polyester and polyether polyols such as WorléePol 230 (Worlée).

Examples of suitable alkanols include ethanediol, propanediol, propanetriol, butanediol, butanetriol, pentanediol, pentanetriol, hexanediol, hexanetriol, heptanediol; heptanetriol, octanediol, octanteriol, nonanediol, nonanetriol, decanediol and decanetriol.

For the case that the composition of the intended application cures too slowly, especially when polyaspartic acid esters are being used, a tertiary amine may be further added as catalyst to the composition.

If the composition also contains polyols, and for the case that the composition cures too slowly for the intended application, a catalyst selected from among tin-containing compounds, bismuth-containing compounds, zirconium-containing compounds, aluminum-containing compounds, or zinc-containing compounds may be further added as catalyst to the composition. Preferably such compounds are tin octoate, tin oxalate, tin chloride, dioctyltin bis-(2-ethylhexanoate), dioctyltin dithioglycolate, dibutyltin dilaurate, monobutyltin tris-(2-ethylhexanoate), dioctyltin dineodecanoate, dibutyltin dineodecanoate, dibutyltin diacetate, dibutyltin oxide, monobutyltin di hydroxychloride, organotin oxide, monobutyltin oxide, dioctyltin dicarboxylate, dioctyltin stannoxane, bismuth carboxylate, bismuth oxide, bismuth neodecanoate, zinc neodecanoate, zinc octoate, zinc acetylacetonate, zinc oxalate, zinc acetate, zinc carboxylate, aluminum chelate complex, zirconium chelate complex, dimethylaminopropylamines, N,N-dimethylcyclohexylamine, N,N-dimethylethanolamine, N-(3-dimethylaminopropyl)-N,N-diisopropanolamine, N-ethylmorpholine, N-methylmorpholine, pentamethyldiethylenetriamine and/or triethylenediamine.

Examples of suitable catalysts are Borchi® Kat 24, Borchi® Kat 320, Borchi® Kat 15 (Borchers), TIB KAT 129, TIB KAT P129, TIB KAT 160, TIB KAT 162, TIB KAT 214, TIB KAT 216, TIB KAT 218, TIB KAT 220, TIB KAT 232, TIB KAT 248, TIB KAT 248 LC, TIB KAT 250, TIB KAT 250, TIB KAT 256, TIB KAT 318, TIB Si 2000, TIB KAT 716, TIB KAT 718, TIB KAT 720, TIB KAT 616, TIB KAT 620, TIB KAT 634, TIB KAT 635, TIB KAT 815 (TIB Chemicals), K-KAT® XC-B221, K-KAT® 348, K-KAT® 4205, K-KAT® 5218, K-KAT® XK-635, K-KAT® XK-639, K-KAT® XK-604, K-KAT® XK-618 (King Industries), JEFFCAT® DMAPA, JEFFCAT® DMCHA, JEFFCAT® DMEA, JEFFCAT® DPA, JEFFCAT® NEM, JEFFCAT® NMM, JEFFCAT® PMDETA, JEFFCAT® TD-100 (Huntsman) and DABCO 33LV (Sigma Aldrich).

The mechanism of action of the inventive ablatively acting composition is based on an endothermic physical and/or chemical reaction, wherein substances that need large amounts of energy for their decomposition are contained in the composition. If the cured composition is exposed to elevated temperature, such as that in the case of a fire, for example, a series of chemical and physical processes is initiated. These processes are, for example, the release of water vapor, change of the chemical composition and the formation of incombustible gases, which keep the oxygen needed for combustion away from the cable surface. All of these processes need a large amount of energy, which is drawn from the fire. After the conversion of all organic ingredients has ended, a stable insulating layer of inorganic ingredients has been formed, with an additional insulating effect.

According to the invention, ingredient C therefore contains at least one ablatively acting fire-protection additive, wherein both individual compounds and also a mixture of several compounds may be used as additive.

Expediently, materials that form energy-consuming layers by elimination of water, which is incorporated in the form of water of crystallization, for example, and by evaporation of water, are used as ablatively acting fire-protection materials. In this connection, the thermal energy that must be expended for elimination of water is drawn from the fire. Furthermore, materials are used that change chemically or decompose, evaporate, sublime or melt under the effect of heat in an endothermic reaction. Thereby the coated substrates are cooled. Frequently, inert, i.e. incombustible gases such as carbon dioxide, for example, are released during the decomposition, and they additionally dilute the oxygen in the immediate vicinity of the coated substrate.

Suitable gas-eliminating ingredients are hydroxides, such as aluminum hydroxide and magnesium hydroxide as well as their hydrates, which eliminate water, as well as carbonates, such as calcium carbonate, which eliminate carbon dioxide. Basic carbonates are able to eliminate both water and CO₂. A combination of ingredients with gas elimination beginning at various temperatures is preferred. Thus the elimination of water from aluminum hydroxide already begins at approximately 200° C., whereas the elimination of water from magnesium hydroxide sets in at approximately 350° C., and so gas elimination takes place over a broader temperature range.

Suitable ablatively acting materials are inorganic hydroxides that eliminate water under the action of heat, such as those of sodium, potassium, lithium, barium, calcium, magnesium, boron, aluminum, zinc, nickel, also boric acid, and their partly hydrated derivatives.

The following compounds may be mentioned as examples: LiNO₃.3H₂O, Na₂CO₃.H₂O (thermonatrite), Na₂CO₃.7H₂O, Na₂CO₃.10H₂O (soda), Na₂Ca(CO₃)₂.2H₂O (pirssonite), Na₂Ca(CO₃)₂.5H₂O (gaylussite), Na(HCO₃)Na₂CO₃.2H₂O (trona), Na₂S₂O₃.5H₂O, Na₂O₃Si.5H₂O, KF.2H₂O, CaBr₂.2H₂O, CaBr₂.6H₂O, CaSO₄.2H₂O (gypsum), Ca(SO₄).½H₂O (bassanite), Ba(OH)₂.8H₂O, Ni(NO₃)₂.6H₂O, Ni(NO₃)₂.4H₂O, Ni(NO₃)₂.2H₂O, Zn(NO₃)₂.4H₂O, Zn(NO₃)₂.6H₂O, (ZnO)₂(B₂O₃)₂.3H₂O, Mg(NO₃)₂.6H₂O (U.S. Pat. No. 5,985,013 A), MgSO₄.7H₂O (EP1069172A), Mg(OH)₂, Al(OH)₃, Al(OH)₃3H₂O, AlOOH (boehmite), Al₂[SO₄]₃,nH₂O with n=14-18 (U.S. Pat. No. 4,462,831 B), possibly mixed with AINH₄(SO₄)₂.12H₂O (U.S. Pat. No. 5,104,917A), KAI(SO₄)₂.12H₂O (EP1069172A), CaO.Al₂O₃.10H₂O (nesquehonite), MgCO₃.3H₂O (wermlandite), Ca₂Mg₁₄(Al,Fe)₄CO₃(OH)₄₂.29H₂O (thaumasite), Ca₃Si(OH)₆(SO₄)(CO₃).12H₂O (artinite), Mg₂(OH)₂CO₃.H₂O (ettringite), 3CaO.Al₂O₃.3CaSO₄.32H₂O (hydromagnesite), Mg₅(OH)₂(CO₃)₄.4H₂O (hydrocalumite), Ca₄Al₂(OH)₁₄.6H₂O (hydrotalcite), Mg₆Al₂(OH)₁₆CO₃.4H₂O alumohydrocalcite, CaAl₂(OH)₄(CO₃)₂.H₂O scarbroite, Al₁₄(CO₃)₃(OH)₃₆ hydrogarnet, 3CaO.Al₂O₃.6H₂O dawsonite, NaAl(OH)CO₃, water-containing zeolites, vermiculite, colemanite, perlite, mica, alkali silicates, borax, modified carbons and graphites, silicas.

In a preferred embodiment, the hydrated salts are selected from the group consisting of Al₂(SO).16-18H₂O, NH₄Fe(SO₄)₂.12H₂O, Na₂B₄O₇.10H₂O NaAl(SO₄)₂.12H₂O, AINH₄(SO₄)₂.12-24H₂O, Na₂SO₄.10H₂O, MgSO₄.7H₂O, (NH₄)₂5O₄.12H₂O; KAI(SO₄)₂.12H₂O, Na₂SiO₃.9H₂O, Mg(NO₂)₂.6H₂O, Na₂CO₃.7H₂O and mixtures thereof (EP1069172A).

Aluminum hydroxide, aluminum hydroxide hydrates, magnesium hydroxide and zinc borate are particularly preferred, since they have an activation temperature below 180° C.

Optionally, one or more reactive flame retardants may be added to the inventive composition. Such compounds are incorporated into the binder. Examples within the meaning of the invention are reactive organophosphorus compounds, such as 9,10-dihydro-9-oxa-10-phosphaphenanthrene-10-oxide (DOPO) and its derivatives and adducts. For example, such compounds are described in S. V Levchik, E. D Weil, Polym. Int. 2004, 53, 1901-1929 or E. D. Weil, S. V. Levchik (Eds.), Flame Retardants for Plastics and Textiles—Practical Applications, Hanser, 2009.

The ablatively acting fire-protection additive may be present in the composition in a proportion of 5 to 99 wt %, wherein the proportion depends substantially on the form of application of the composition (spraying, painting and the like). In order to obtain the best insulation possible, the proportion of ingredient C in the total formulation is adjusted to be as high as possible. Preferably the proportion of ingredient C in the total formulation is 5 to 85 wt % and particularly preferably 40 to 80 wt %.

Besides the insulation-layer-forming additives, the composition may if necessary contain common auxiliary agents, such as solvents, for example xylene or toluene, wetting agents, for example on the basis of polyacrylates and/or polyphosphates, anti-foaming agents, such as silicone anti-foaming agents, thickeners, such as alginate thickeners, dyes, fungicides, plasticizers, such as chlorine-containing waxes, binders, flame retardants or diverse fillers, such as vermiculite, inorganic fibers, silica sand, glass microbeads, mica, silicon dioxide, mineral wool and the like.

Further additives such as thickeners, rheology additives and fillers may be included in the composition. Preferably polyhydroxycarboxylic acid amides, urea derivatives, salts of unsaturated carboxylic acid esters, alkylammonium salts of acid phosphoric acid derivatives, ketoximes, amine salts of p-toluenesulfonic acid, amine salts of sulfonic acid derivatives as well as aqueous or organic solutions of mixtures of the compounds are used as rheology additives, such as anti-settling agents, anti-sagging agents and thixotropic agents. Rheology additives on the basis of pyrogenic or precipitated silicas or on the basis of silanized pyrogenic or precipitated silicas may also be used. Preferably the rheology additive is pyrogenic silicas, modified and non-modified layer silicates, precipitated silicas, cellulose ethers, polysaccharides, PU and acrylate thickeners, urea derivatives, castor oil derivatives, polyamides and fatty acid amides and polyolefins, provided they exist in solid form, pulverized celluloses and/or suspension agents, such as xanthan gum, for example.

The inventive composition may be packaged as a two-component or multi-component system.

Since a reaction takes place at room temperature, ingredient A and ingredient B must be disposed separately in a way that inhibits the reaction. In the presence of a catalyst, this may either be stored separately from ingredients A and B or it may be contained in one of these ingredients or divided between both ingredients. Hereby it is ensured that the two components A and B of the binder are mixed with one another and the curing reaction is initiated only directly before application. This makes the system easier to handle.

In a preferred embodiment of the invention, the inventive composition is packaged as a two-component system, wherein ingredient A and ingredient B are disposed separately in a way that inhibits the reaction. Accordingly, a first component, component I, contains ingredient A, and a second component, component II, contains ingredient B. Hereby it is ensured that the two ingredients A and B of the binder are mixed with one another, and the curing reaction is initiated only directly before application. This makes the system easier to handle.

Ingredient C may then be contained as the total mixture or divided into individual components in a first component I and/or a second component II. Ingredient C is divided in a way that depends on the compatibility of the compounds contained in the composition, so that neither a reaction or mutual interference of the compounds contained in the composition with one another nor a reaction of these compounds with the compounds of the other ingredients can take place. This depends on the compounds being used. Hereby it is ensured that the highest possible proportion of fillers can be achieved. This leads to high intumescence, even with small layer thicknesses of the composition.

The composition is applied as a paste with a paintbrush or a roller or by spraying onto the substrate. This substrate may be metallic or may consist of another nonmetallic material, such as plastic, for example, in the case of cables, or of mineral wool in the case of soft partitions, or of a material combination, for example of metallic and nonmetallic materials, as in the case of cable runs. Preferably the composition is applied by means of an airless spraying method.

Compared with systems based on solvents and water, the inventive composition is characterized by relatively rapid curing due to an addition reaction and thus not by the need for physical drying. This is very important especially when the coated building parts must be rapidly loaded or reprocessed, whether this be due to coating with a covering layer or to movement or transportation of the building parts. Thus the coating is also much less susceptible to external influences on the building site, such as, for example, exposure to (rain) water or dust and dirt, which in systems based on solvents or water may lead to leaching of water-soluble ingredients or to reduced ablative effect due to uptake of dust. Due to the low viscosity of the composition despite the high solids proportion, which may be as high as 99 wt % in the composition without the addition of highly volatile solvents, the composition remains easy to process, especially by common spraying methods.

Therefore the inventive composition is suitable in particular as a fire-protection coating, especially as a sprayable coating for building parts on a metallic and nonmetallic basis. The inventive composition is used mainly in the building sector as a coating, especially as a fire-protection coating for individual cables, cable bundles, cable runs and cable ducts or other lines and also as a fire-protection coating for steel construction elements, although also for construction elements of other materials, such as concrete or wood.

Further subject matter of the invention is therefore the use of the inventive composition as a coating, especially as a coating for construction elements or building elements of steel, concrete, wood and other materials, such as plastics, for example, especially as a fire-protection coating for individual cables, cable bundles, cable runs and cable ducts or other lines or soft partitions.

The present invention also relates to objects obtained when the inventive composition has cured. The objects have excellent ablative properties.

The invention will be further explained on the basis of the following examples.

### EXEMPLARY EMBODIMENTS

The ingredients listed in the following are used to manufacture inventive ablatively acting compositions. The respective individual components are mixed and homogenized by means of a dissolver. For application, these mixtures then are either mixed before spraying or mixed and applied during spraying.

To determine the fire-protection properties, the cured composition was subjected to a test according to EN ISO 11925-2, while the flammability and dripping behavior were determined according to CEN/TS 45545-2 (HTC SFS test). The test was performed in a Mitsubishi FRD700SC Electric Inverter firebox, set up to be tension-free. During the test, a small burner flame was directed onto the sample surface at an angle of 45° for 30 s. This corresponds to surface flaming.

Samples with dimensions of 11 cm×29.5 cm and an application thickness of 1 mm were used in each case. These samples were cured at room temperature and aged for three days at 40° C.

After three days of aging at 40° C., the test was performed for flammability and height of the attacked surface.

The curing time and the course of curing were determined. For this purpose, a spatula was used to test when curing of the coating began.

For the following Examples 1 and 2, aluminum trihydrate (HN 434 of J. M. Huber Corporation, Finland) was used as ingredient C, in quantities of 15 g in each case.

### EXAMPLE 1

Ingredient A

| Ingredient | Quantity [g] |
|---|---|
| Desmophen ® NH 1420 ¹⁾ | 34.5 |
| 1-Decanol | 8.5 |
| Calcium carbonate | 45.0 |

¹⁾ Polyaspartic ester on the basis of a cycloaliphatic amine (amine number 199-203 mg KOH/g (M129-AFAM 2011-06054); viscosity (25° C.) 900-2.000 mPa · s (M068-DIN 53019); equivalent weight 276 g/eq)

Ingredient B

| Ingredient | Quantity [g] |
|---|---|
| Desmodur N 3900 ²⁾ | 32.0 |
| Calcium carbonate | 15.0 |

²⁾ low-viscosity, aliphatic polyisocyanate resin on the basis of hexamethylene diisocyanate (NCO content 23.5 ± 0.5 wt-% (DIN EN ISO 11 909); viscosity (23° C.) 730 ± 100 mPa · s (DIN EN ISO 3219/A.3); equivalent weight approximately 179 g/eq)

### EXAMPLE 2

Ingredient A

| Ingredient | Quantity [g] |
|---|---|
| Desmophen NH 1420 | 31.4 |
| Polyglycol 600 | 14.6 |
| Calcium carbonate | 45 |

Ingredient B

| Ingredient | Quantity [g] |
|---|---|
| Desmodur N 3900 | 29.1 |
| Calcium carbonate | 15.0 |

### COMPARISON EXAMPLE 1

A commercial fire-protection product (Hilti CFS SP-WB) based on aqueous dispersion technology (acrylate dispersion) was used for comparison.

TABLE 1
Results of the determination of curing
time, ignition and flame height

| Example | Comparison 1 | 1 | 2 |
|---|---|---|---|
| Curing time | 24 h | 30 min | 14 min |
| Ignition | yes | yes | yes |
| Flame height | 150 mm | 110 mm | 30 mm |

1. A fire-protection composition, comprising:
an ingredient A, which contains an isocyanate compound,
an ingredient B, which contains a reactive component capable of reacting with an isocyanate compound and which is selected from the group consisting of compounds with at least two amino groups, wherein the amino groups, independently of one another, are primary and/or secondary amino groups, and
an ingredient C, which contains an ablatively acting fire-protection additive.

2. The composition according to claim 1, wherein the reactive component capable of reacting with the isocyanate compound is selected from the group consisting of polyamines, polyether polyamines, polyaspartic acid esters and a mixture thereof.

3. The composition according to claim 2, wherein the reactive component capable of reacting with the isocyanate compound is a polyether polyamine, which is selected from among the group consisting of compounds of general formula (I) 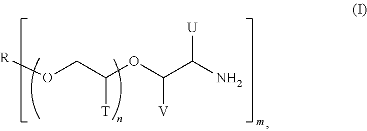
in which
R is a group of an initiator for oxalkylation with 2 to 12 carbon atoms and 2 to 8 groups containing an active hydrogen atom,
T represents hydrogen or a C₁-C₄ alkyl group,
V and U, independently of one another, are hydrogen or T,
n is a value between 0 and 100,
m is a whole number between 2 and 8, wherein m corresponds to the number of groups that contain an active hydrogen atom and that were initially contained in the initiator for oxalkylation.

4. The composition according to claim 2, wherein the reactive component capable of reacting with the isocyanate compound is a polyaspartic acid ester of general formula (VII), 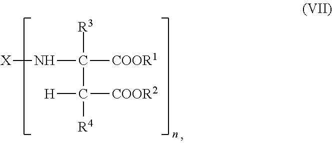
in which
R¹ and R² may be identical or different and stand for organic groups that are inert toward isocyanate groups,
R³ and R⁴ may be identical or different and stand for hydrogen or organic groups that are inert toward isocyanate groups,
X stands for an n-valent organic group that is inert toward isocyanate groups, and
n stands for a whole number of at least 2.

5. The composition according to claim 4, wherein, in formula (VII), R¹ and R², independently of one another, stand for a methyl or ethyl group and R³ and R⁴ each stand for hydrogen.

6. The composition according to claim 4, wherein, in formula (VII), X stands for a group which is obtained by removal of primary amino groups from an aliphatic polyamine.

7. The composition according to claim 1, wherein ingredient B further contains a polyol compound.

8. The composition according to claim 7, wherein the polyol compound is selected from the group consisting of polyester polyols, polyether polyols, hydroxylated polyurethanes, and/or alkanes with at least two hydroxyl groups each per molecule and a mixture thereof.

9. The composition according to claim 1, wherein the isocyanate compound comprises an aliphatic or aromatic skeleton and at least two isocyanate groups or a mixture thereof.

10. The composition according to claim 1, wherein the quantitative ratios of ingredients A and B are chosen such that the equivalent ratio of isocyanate groups of the isocyanate compound to groups, capable of reacting with the isocyanate group, of the reactive component capable of reacting with the isocyanate compound lies between 0.3 and 1.7.

11. The composition according to claim 7, which further contains a catalyst for the reaction between the isocyanate compound and the reactive component capable of reacting with the isocyanate compound and/or the polyol.

12. The composition according to claim 1, wherein the at least one ablatively acting fire-protection additive is selected from the group consisting of LiNO₃.3H₂O, Na₂CO₃.H₂O (thermonatrite), Na₂CO₃.7H₂O, Na₂CO₃.10H₂O (soda), Na₂Ca(CO₃)₂.2H₂O (pirssonite), Na₂Ca(CO₃)₂.5H₂O (gaylussite), Na(HCO₃)Na₂CO₃.2H₂O (trona), Na₂S₂O₃.5H₂O, Na₂O₃Si.5H₂O, KF.2H₂O, CaBr₂.2H₂O, CaBr₂.6H₂O, CaSO₄.2H₂O (gypsum), Ca(SO₄). ½H₂O (bassanite), Ba(OH)₂.8H₂O, Ni(NO₃)₂.6H₂O, Ni(NO₃)₂.4H₂O, Ni(NO₃)₂ 2H₂O, Zn(NO₃)₂.4H₂O, Zn(NO₃)₂.6H₂O, (ZnO)₂(B₂O₃)₂.3H₂O, Mg(NO₃)₂.6H₂O (U.S. Pat. No. 5,985,013 A), MgSO₄.7H₂O (EP1069172A), Mg(OH)₂, Al(OH)₃, Al(OH)₃.3H₂O, AlOOH (boehmite), Al₂[SO₄]₃.nH₂O with n=14-18 (U.S. Pat. No. 4,462,831 B), possibly optionally mixed with AlNH₄(SO₄)₂.12H₂O (U.S. Pat. No. 5,104,917 A), KA1(SO₄)₂.12H₂O (EP1069172A), CaO.Al₂O₃.10H₂O (nesquehonite), MgCO₃.3II₂O (wermlandite), Ca₂Mg₁₄(Al,Fe)₄CO₃(OII)₄₂.29II₂O (thaumasite), Ca₃Si(OH)₆(SO₄)(CO₃).12H₂O (artinite), Mg₂(OH)₂CO₃.H₂O (ettringite), 3CaO.Al₂O₃.3CaSO₄.32H₂O (hydromagnesite), Mg₅(OH)₂(CO₃)₄.4H₂O (hydrocalumite), Ca₄Al₂(OH)₁₄.6H₂O (hydrotalcite), Mg₆Al₂(OH)₁₆CO₃.4H₂O alumohydrocalcite, CaAl₂(OH)₄(CO₃)₂.H₂O scarbroite, Al₁₄(CO₃)₃(OH)₃₆ hydrogarnet, 3CaO.Al₂O₃.6H₂O dawsonite, NaAl(OH)CO₃, water-containing zeolites, vermiculite, colemanite, perlite, mica, alkali silicates, borax, modified carbons, modified graphites, silicas and mixtures thereof.

13. The composition according to claim 1, wherein the composition further contains organic and/or inorganic aggregates and/or a further additive.

14. The composition according to one of the claim, which is packaged as a two-component or multi-component system.

15. A coating, comprising:
the composition according to one of claim 1.

16. A construction element, comprising:
the coating according to claim 15.

17. The construction element according to claim 16 which is a nonmetallic construction element.

18. The coating according to claim 15 which is a fire-protection coating.

19. A cured object, obtained by curing the composition according to claim 1.

20. A cable, cable bundle, cable run, cable duct, line or soft partition, comprising: the coating according to claim 18.
